(19) United States
(12) Patent Application Publication
(10) Pub. No.: US 2002/0172462 A1
(43) Pub. Date: Nov. 21, 2002

(54) Method and apparatus for thermally tuning an optical filter

(76) Inventors: Qian Tao, Brossard (CA); Bing Zhou, Verdun (CA); Jun Tian, Brossard (CA)

Correspondence Address: MCDERMOTT WILL & EMERY, 600 13TH STREET, N.W., WASHINGTON, DC, 20005-3096, US

(21) Appl. No.: 10/105,789

(22) Filed: Mar. 26, 2002

Related U.S. Application Data
(60) Provisional application No. 60/278,415, filed on Mar. 26, 2001.

(51) Int. Cl. G02B 6/34; G02B 6/00

(52) U.S. Cl. 385/37; 385/136

(57) ABSTRACT

A mechanical amplifier is disclosed for thermally tuning an optical filter. Two arms retain an optical fiber, and an expander is placed between the two arms. Ends of the arms are connected to each other, so that when there is a temperature variation, the distance between the two arms changes, thereby stretching or compressing the optical filter.

### FIELD OF THE INVENTION

The present invention relates generally to optical filters which can be thermally tuned, and more particularly to fibre gratings tuneable by thermal strain.

### BACKGROUND OF THE INVENTION

Optical fibre filters, and more particularly fibre gratings are well known in the art. The centre wavelength of a typical optical fibre grating is fixed by imprinting a certain periodic change of the refractive index in the core of an optical fibre. While it is desirable to make this parameter stable in most applications, some applications require tuning. By exerting exterior factors to a fibre grating, such as strain and compression, the wavelength can be affected, and thus the grating tuned.

The wavelength-tuneable grating can be used, for example, as a transducer element in fibre sensors; a wavelength control device for fibre, semi-conductor, and solid state lasers; a wavelength division multiplexing component in a communication system; a wavelength analyser; a component in a signal processing systems (see U.S. Pat. No. 5,469,520).

One of the common ways to change the wavelength of a fibre Bragg grating is by mechanically stretching the fibre grating along its axis. However, changes in the ambient temperature will also affect the wavelength of the grating. In fact, one way to change the wavelength of a fibre grating is to alter the temperature of the fibre grating region, as taught in U.S. Pat. No. 5,809,188, However, the lower rate of the wavelength shift to temperature and the grating degradation at lower temperatures limit the wavelength tuning range of a fibre grating using temperature variations.

### SUMMARY OF THE INVENTION

An objective of the present invention is to provide a method and device to increase the temperature sensitivity and tuning range of the centre wavelength of optical filters such as fibre gratings.

A further objective of the present invention is to provide a method and device for tuning the centre wavelength of the fibre optical gratings by heating and cooling a mechanical structure.

Yet, another object of the present invention is to provide a method and device to combine both tuning approaches of stretching the grating and maintaining stability in fibre region to obtain wide wavelength tuning range and stability within a range of ambient temperature.

According to the present invention the tuneable optical grating comprises a mechanical amplifier of bi-metal structure with different thermal coefficients that generate a certain displacement from deformation of its components, and a certain axial strain on the fibre grating mounted on the structure for tuning its wavelength when the temperature applied to the structure is changed.

In accordance with the invention, these and other objects are achieved with An apparatus for thermally tuning an optical filter comprising: a pair of arms, each arm having a securing end for securing a portion of an optical fibre therebetween and a joining end, said pair of arms being secured together at their respective joining ends; an expander connected to each arm for increasing or decreasing a distance between said securing ends. Preferably, the expander is an expansion bar.

The foregoing and other objects, features and advantages of the present invention will become more apparent from the following detailed description of the embodiment of the present invention in conjunction with the accompanying drawings.

### BRIEF DESCRIPTION OF THE DRAWINGS

FIGS. 1A and 1B are schematic front and side views, respectively, of a mechanical amplifying component for stretching the tuned fibre grating, in accordance with the present invention.

FIG. 2 is a graph of the centre wavelength against applied temperature to the tuneable fibre grating, in accordance with the present invention.

FIG. 3 is a schematic side view of a mechanical amplifying component according to a variation of the preferred embodiment of FIG. 1.

### DESCRIPTION OF A PREFERRED EMBODIMENT OF THE INVENTION

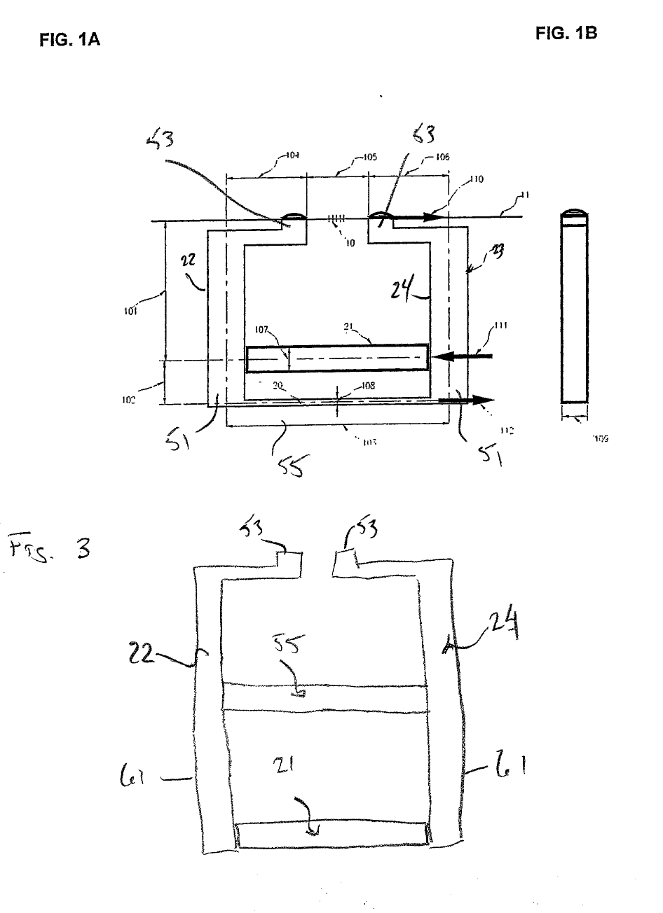

Referring to FIG. 1A and FIG. 1B, an optical fibre 11 with fibre grating 10, whose centre wavelength is to be tuned, is attached to a mechanical amplifier 1 that consists of a pair of arms 22, 24 each having a joining end 51 and a receiving end 53. The joining ends are joined together, preferably through a bridge 55 in order to provide a “U” shaped support member 23 that is made of material of a first expansion coefficient. An expander 21, which is preferably an expansion bar that is made of material of a second expansion coefficient, where the second expansion coefficient is higher than the first expansion coefficient is connected to the two arms, preferably between the joining ends and the securing ends. When the temperature applied to the device is increased, the expansion bar 21 will expand and that will cause flexural deformation on the bottom portion 20 of the support member 23 (or the bridge). The force 112 (Fₛ) caused by the deformation of the portion 20 will be transferred to the fibre grating through the arms of the support member 23, which act as an amplifier. Considering that the expansion is also generated on the support member 23 and its bottom portion 20, and the internal force 111 (Fₑ) also causes deformation of the expansion bar 21 during this process, the materials of the support member 23 and the expansion bar 21 should be selected to have quite different thermal expansion coefficients. In fact, in a preferred embodiment of the invention, the expansion bar 21 is designed to be strong enough to reduce or eliminate the effect of the deformation caused by force 111 (Fₑ), and the arms of support member 23 should also be designed to be stronger enough to prevent flexural deformations caused by reactions of forces 110 (F_{g}), 111 (Fₑ), 112 (F_{s).}

With a given temperature increment ΔT, the deformations of the expansion bar 21, which define a length 103 (lₑ) and cross sectional area (Sₑ), and the bottom portion 20 of the support member 23, which define a length 103 (lₛ=lₑ) and cross sectional area (Sₛ), are respectively:

Δlₑ=αₑ*ΔT−Fₑlₑ/Eₑ*Sₑ

Δlₛ=αₛ*ΔT−Fₛlₛ/Eₛ*Sₛ

Where the αₑ, αₛ, are the thermal expansion coefficients and Eₑ, Eₛ are the elastic modulus of the expansion bar 21 and the support member 23, respectively.

Considering that the mechanical structure of this design is mainly for amplifying the placement of deformation of the expansion bar 21, the length lₐ of the portion 101 should much longer than the length l_{b} of the portion 102. The proportion (P) of the lengths of portion 101 and 102 is defined as P=lₐ/l_{b}. The internal force F_{g} of the fibre grating 10 caused by the deformation of the expansion bar 21 is P times less that the internal force Fₛ, and the effect of the elastic deformation of portion 104 and portion 106 caused by force F_{g} is less effective on the placement of grating 10 caused by expansion bar 21. Disregarding the effects of the flexural deformation of portion 101 and elastic deformation of the portions 104 and 106, the placement of the fibre grating 10 can be calculated as follows:

Δl_{g}=Δlₛ+(Δlₑ−Δlₛ)*(lₐ+l_{b})/l_{b}−Δlₗ−Δlᵣ=Δlₑ*(1+P)−Δlₛ*P−Δlₗ−Δlᵣ

Where P=lₐ/l_{b}, and Δlₗ, Δlᵣ are the thermal expansions of portion 104 and portion 106 caused by temperature variation ΔT, respectively. According to the definition of elastic modulus, the internal force F_{g} of fibre grating 10 is determined by following expression:

$${F}_{g} = \frac{Δ {l}_{g}}{{l}_{g}} * {E}_{g} * {S}_{g}$$

Here l_{g} is the length 105, E_{g} is the elastic modulus and S_{g} is the cross sectional area of the fibre grating 10.

The internal forces Fₛ, Fₑ of the bottom portion 20 and the expansion bar 21 are determined by following expressions, respectively:

$$\begin{matrix}{F}_{s} = P * {F}_{g} = \frac{Δ {l}_{g}}{{l}_{g}} * P * {E}_{g} * {S}_{g} \\ {F}_{e} = ( 1 + P ) * {F}_{g} = \frac{Δ {l}_{g}}{{l}_{g}} * ( 1 + P ) * {E}_{g} * {S}_{g}\end{matrix}$$

With a temperature variation ΔT, the deformations of the expansion bar 21, the bottom portion 20 and the fibre grating 10 are given as follows:

$$Δ {l}_{e} = {α}_{e} * {l}_{e} * Δ T - ( 1 + P ) * Δ {l}_{g} * {E}_{g} * {S}_{g} \frac{{l}_{e}}{{l}_{g} * {E}_{e} * {S}_{e}}$$

$$Δ {l}_{s} = {α}_{s} * {l}_{s} * Δ T + P * Δ {l}_{g} * {E}_{g} * {S}_{g} \frac{{l}_{s}}{{l}_{g} * {E}_{s} * {S}_{s}}$$

$$Δ {l}_{g} = {α}_{e} {l}_{e} Δ T ( 1 + P ) - {α}_{s} {l}_{s} Δ T P - {α}_{s} {l}_{l} Δ T - {α}_{s} {l}_{r} Δ T - \frac{Δ {l}_{g} {E}_{g} {S}_{g}}{{l}_{g}} \{ \frac{{( 1 + P )}^{2} {l}_{e}}{{E}_{e} {S}_{e}} + \frac{{P}^{2} {l}_{s}}{{E}_{s} {S}_{s}} \}$$

$$Δ {l}_{g} = \frac{{α}_{e} {l}_{e} Δ T ( 1 + P ) - {α}_{s} {l}_{s} Δ T P - {α}_{s} Δ T ( {l}_{l} + {l}_{r} )}{1 + \frac{{E}_{g} {S}_{g}}{{l}_{g}} ( \frac{{( 1 + P )}^{2} {l}_{e}}{{E}_{e} {S}_{e}} + \frac{{P}^{2} {l}_{s}}{{E}_{s} {S}_{s}} )}$$

The centre wavelength variation of the optic fibre grating 10 due to the given temperature increment AT can be calculated by calculating the strain (Δl_{g}/l_{g}) in the fibre grating 10.

For example, with 60° C. of temperature increment and SMF-128 (9.25/125/250) fibre grating, and aluminium is chosen as the material of the expansion bar 21 and steel as the material of the support member 23, we have

E_{g}=72.4GPa (Stripped optical-fibre);

Eₑ=68GPa;

Eₛ=206GPa;

S_{g}=0.01227 mm²;

αₑ=23×10⁻⁶/° C.;

αₛ=13×10⁻⁶/° C.;

Taking the length of fibre grating 10 to be l_{g}=lₑ/3 and lₛ=lₑ; the proportion of the lengths of portion 101 and 102 P=4; the thickness 109 of the body (including the expansion bar 21) Δ=2 mm; and 3 mm, 0.5 mm heights for expansion bar 21 and the bottom portion 20 of the support member 23 respectively, we get the result Δl_{g}/l_{g}=0.00716.

The centre wavelength shift Δλ of a fibre grating of centre wavelength λ due to the strain imposed on the fibre grating can be calculated by the following approximate expression:

$$Δ λ = ( 1 - {p}_{e} ) * λ * ( \frac{Δ {l}_{g}}{{l}_{g}} )$$

Here pₑ is a photo-elastic constant of the fibre grating. For typical single-mode fibre, pₑ=0.22.

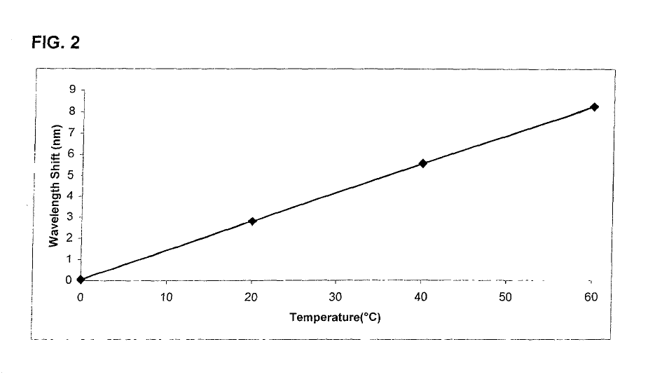

With this design, about 8.6 nm of tuning range can be achieved for 1550 nm fibre grating. FIG. 2 shows a temperature/wavelength curve of the tuneable grating with present invention.

For achieving control temperature span of 0° C.-60° C., the tuned fibre grating should be mounted upon the component with certain pre-strain at room temperature to guarantee that the tuned fibre grating still has stretch strain at 0° C. Instead of using steel as the material of the support member, other metals, which have the properties of low thermal expansion coefficient, low thermal capacity and high thermal conductivity, and some non-metal materials such as ceramic and plastic may be used to increase the strain on the fibre grating and reduce the thermal capacity of the device for raising wavelength response speed. Also, the expansion bar may be exchanged with the bottom portion of the support member for the purpose of compressing the fibre grating. This is shows in FIG. 3, where the arms are provided with extensions projecting longitudinally away from the securing ends 53, and where the expansion bar 21 joins the ends of the projections.

Still further, instead of the expansion bar, a piezoelectric actuator or other actuation means may be used to extend the fibre grating 10.

Although the present invention has been explained hereinabove by way of a preferred embodiment thereof, it should be pointed out that any modifications to this preferred embodiment within the scope of the appended claims is not deemed to alter or change the nature and scope of the present invention.

1. An apparatus for thermally tuning an optical filter comprising:
a pair of arms, each arm having a securing end for securing a portion of an optical fibre therebetween and a joining end, said pair of arms being secured together at their respective joining ends;
an expander connected to each arm for increasing or decreasing a distance between said securing ends.

2. An apparatus for thermally tuning an optical filter according to claim 1, wherein said expander is an expansion bar where said pair of arms are made of a first material having a first thermal coefficient of expansion and said expansion bar is made of a second material having a second thermal coefficient of expansion, said second coefficient of expansion being greater than said first coefficient of expansion.

3. An apparatus for thermally tuning an optical filter according to claim 2, wherein said pair of arms are joined at their joining ends by a bridge, thereby forming a U-shaped structure.

4. An apparatus for thermally tuning an optical filter according to claim 3, wherein said pair of arms and said bridge are made of steel and said expansion bar is made of aluminium.

5. An apparatus for thermally tuning an optical filter according to claim 3, wherein said expansion bar is between said securing ends and said joining ends and closer to said joining ends than to said securing ends.

6. An apparatus for thermally tuning an optical filter according to claim 3, wherein each of said arms is provided with an extension projecting longitudinally away from said securing end, each extension having an end, where said expansion bar is connected to each of said end of said extension.

7. A method for thermally tuning an optical filter comprising the steps of:
(a) providing a mechanical amplifier consisting of a pair of arms, each arm having a securing end for securing a portion of an optical fibre therebetween and a joining end, said pair of arms being secured together at their respective joining ends; an expander connected to each arm for increasing or decreasing a distance between said securing ends;
(b) securing an optical fibre including an optical filter to said securing ends of said arms so that said optical filter is located between said securing ends; and
(c) applying a temperature variation to said mechanical amplifier in order to change a distance between said securing ends.

8. A method according to claim 7, wherein said mechanical amplifier is adapted to function in a range of temperatures between 0° C. and 60° C.
